(19) United States
(12) Patent Application Publication
(10) Pub. No.: US 2017/0050376 A1
(43) Pub. Date: Feb. 23, 2017

(54) Method and Device for the Structural Production of a Hydride Reservoir

(71) Applicant: GKN Sinter Metals Engineering GmbH, Radevormwald (DE)

(72) Inventors: Antonio Casellas, Siegburg (DE); Klaus Dollmeier, Westhausen (DE); Eberhard Ernst, Eichenzell (DE); Markus Laux, Radevormwald (DE)

(21) Appl. No.: 15/307,556

(22) PCT Filed: May 4, 2015
(86) PCT No.: PCT/EP2015/059702

§ 371 Date: Oct. 28, 2016

(30) Foreign Application Priority Data
May 5, 2014 (DE) 10 2014 006 366.6

(51) Int. Cl. B29C 67/00; F17C 11/00; B33Y 80/00; B33Y 10/00; B33Y 30/00

(52) U.S. Cl. CPC B29C 67/0081; B33Y 10/00; B33Y 30/00; B33Y 80/00; B29C 67/0092; F17C 11/005; B29L 2031/712

(57) ABSTRACT

The invention relates to a method for the production of a hydride reservoir having a hydrogenizable material, wherein at least one part of the hydride reservoir is produced by means of a 3-D printer.

The present patent application claims the priority of German patent application 10 2014 006 366.6, the content of which is hereby incorporated by reference into the subject matter of the present patent application.

The invention relates to a process for producing a hydride storage element comprising hydrogen storage material.

A process for producing a hydride storage means is known from US-A-2010/0326992. In this process, uniform hydride storage means in the form of sheets comprising hydrogenatable magnesium and expanded natural graphite are arranged alongside one another. The hydride storage means are moved here onto a temperature control medium feed, or the temperature control medium feed is moved through the hydride storage means. The hydride storage means are obtained beforehand by compressing a composition composed of hydrogenated magnesium powder and particles of expanded natural graphite.

The use of such uniform hydride storage means has the disadvantage that, in applications where a defined space for a hydride storage means has a complex geometry, such a space cannot be filled completely. For example, in the case of such a process, angled spaces and/or spaces having undercuts are difficult to fill with the hydride storage means, since, for this purpose, the feed for temperature control medium has to be installed in curved form and the hydride storage means in the form of sheets form dead spaces at an outer radius of the curved shape of the temperature control medium feed.

It is therefore an object of the present invention to provide a process for producing a hydride storage means in which a space defined by its use is utilized more efficiently.

This object is achieved in accordance with the invention by a process having the features of claim 1 and a hydride storage means having the features of claim 17. Advantageous configurations and developments of the invention will be apparent from the other claims, the description and the figures.

In order to provide a process for producing a hydride storage means in which a space defined by its use is utilized more efficiently, it is proposed that at least a portion of the hydride storage means be produced by means of a 3D printer. The thickness of the individual structures of the hydrogenatable material may, for example, be 20 to 100 μm. A structure is preferably produced by the steps which follow.

In a first step, a geometric description of a structure to be produced for the hydride storage means to be produced is read out. The geometric description of such a structure to be produced is stored, for example, in a file, preferably in a CAD file, and is read out by means of a computer coupled to the 3D printer.

The file advantageously has a complete geometric description of the hydride storage means to be produced in the form of a plurality of substructures arranged alongside one another. Preferably, the file has the complete geometric description for each individual substructure to be produced for the hydride storage means. The geometric description of the overall structure to be produced may be given in the form of points arranged alongside one another with their respective coordinates, with a totality of these points constituting the shape of the structure to be produced.

However, the geometric description can also be achieved by means of geometric approximation via splines or other mathematical functions. Preferably, the 3D printer converts the geometric description of the structure to be produced to individual coordinates of points arranged alongside one another, with the totality of these points forming a two-dimensional shape of the structure to be produced.

In a second step, the material, preferably the hydrogen storage material, is brought to a point within the working space of the 3D printer corresponding to at least one point in the structure to be produced. More preferably, the material is transported to all sites which, in their totality, form the structure to be produced. The sites to which the material is transported may form a volume which encompasses not just all the adjacent points in the structure to be produced, but in particular also further points arranged between the adjacent points in the structure to be produced. In a further configuration of the process, the material is also transported to sites corresponding to none of the points which form the shape of the structure to be produced. For example, it is possible to form a layer of which only the region or those regions that is/are to be utilized in accordance with the specifications is/are utilized. The unutilized regions of the layers can later be separated from one another and reused. More particularly, it is thus possible likewise to form different layer structures of different functionality.

The use of a 3D printer has the advantage of controlled use of materials and their functionality therein, including those that would otherwise not be combinable directly. For example, it is possible firstly to use aluminum as heat conductor of the hydrogen storage means, which is shielded from magnesium, for example, by arrangement of carbon. Graphite in a polymorph used serves here as insulator for a high-temperature hydride material. As a result, pairs of materials are enabled that are otherwise not achievable in a usable manner in other production processes.

In a further configuration of the process, a third step of the process comprises supply of a heat-conducting material to a site within the working space of the 3D printer which corresponds to at least one point in the structure to be produced. The heat-conducting material may especially be graphite and/or a metal, for example aluminum.

In a development of the process, a fourth step comprises stabilization of the material, preferably the hydrogen storage material. The material is solidified at the respective sites to which material has previously been transported, or stabilized at the sites which, in their totality, form the structure to be produced. The stabilization or curing can be effected, for example, by means of a support structure, supply of heat, supply of light, for example by means of laser, UV or IR radiation, an electron melting method and/or a pressing device of the 3D printer or a chemical reaction of the material with another substance. It is also possible to achieve this by means of cooling of a polymer, especially a thermoplastic binder, solidification of a liquid material component, by cooling or by reaction.

Steps one, two, three and/or four are conducted separately or together as often as required for an overall structure of the hydride storage element corresponding to the geometric description to have been produced. A structure to be produced may also be produced by a single first, second, third and/or fourth step. The sequence of steps one to four may vary. In particular, step one may follow step two. For example, the material can first be transported to a site corresponding to a point in the structure to be produced, and then a geometric description of the structure to be produced for the hydride storage means to be produced can be read out. It is also possible for a controlled arrangement of the material to be accompanied simultaneously by a solidification or stabilization.

In a further configuration of the process, at least steps one, two, three and/or four are repeated, with arrangement of the structures formed alongside one another and formation of at least a portion of the hydride storage element.

More preferably, the structure is produced layer by layer. Advantageously, the structures produced are arranged in layers, preferably one on top of another.

At least one of the following functions “primary hydrogen storage”, “primary heat conduction” and/or “primary gas conduction” is understood to mean that a particular layer and/or region produced, for example, by means of the 3D printer assumes at least this as a main object in the structure. For instance, it is possible that a region of the structure is utilized primarily for hydrogen storage, but is simultaneously also capable of providing at least a certain thermal conductivity. At the same time, however, at least one other layer or another region of the structure that primarily assumes the task of heat conduction is present, in other words which is used to dissipate the greatest amount of heat from the structure. In this case, it is possible in turn to utilize the primarily gas-conducting layer or a primarily gas-conducting region of the structure, by means of which, for example, the hydrogen is guided into the material composite or else, for example, guided out of it. In this case, the flowing fluid can also entrain heat.

In an advantageous manner, there is variation in the two-dimensional forms of the structures to be produced. In this case, for example, an outer form of the hydride storage element can be produced to match a defined space, the defined space preferably being determined by the use of the hydride storage element.

The space defined by a use of the hydride storage element may, for example, be defined in mobile applications, for example in a motor vehicle. In this case, because of high demands in the case of integration in a motor vehicle, it is advantageous to position the hydride storage element in available cavities in the bodywork. Such defined spaces for the hydride storage element may have very complex shapes, and these shapes may also have undercuts.

By means of the process proposed, it is possible to produce a hydride storage element by means of various shaped structures arranged alongside one another, such that it is also possible to fill complex shapes of a defined space also having undercuts. Particularly advantageously, the geometric descriptions of the structures of the hydride storage element to be produced are produced to match a geometry of the defined space. In this case, preferably, a file which describes the defined space can be read in and adjusted such that the hydride storage means to be produced is produced in such a way that it can be installed into the defined space.

Any variation in the shapes of the structures to be produced additionally promotes production of complex-shaped temperature control medium feeds and/or temperature control medium returns within the hydride storage element. In this case, in the geometric descriptions of the structures of the hydride storage means to be produced, cavities are provided, which form at least one temperature control medium feed and/or temperature control medium return channel. In addition, it is also possible to provide cavities in the production of the structures of the hydride storage element for a channel for feeding in hydrogen.

In an advantageous development of the process, a filter is produced between a channel for feeding in hydrogen and the hydride storage element by means of a 3D printer. The filter may comprise palladium, metal hydride, silicone, silicone-based polymers or further hydrogen-permeable materials. The filter can be produced, for example, by selective laser sintering.

A further configuration of the process envisages stabilization of the material by means of a support structure surrounding the material. It may be the case that the support structure is produced with a polymer. In addition, the support structure may be produced with a carbonaceous material, especially with a graphite. In addition, a support structure may be generated by means of a wire, especially a metal wire of high thermal conductivity preferably comprising copper, aluminum, silver and/or gold. For example, material can be applied by means of a wire, for example wire welding, preferably aluminum or copper wire welding.

By means of the preferably structured production of the hydride storage element by means of the 3D printer, it is possible to produce any desired shapes of temperature control medium feeds, temperature control medium returns, channels for feeding in hydrogen and/or the filter within each structure to be produced. For example, a star-shaped or rounded star-shaped boundary region may be provided between the hydride storage means and the filter material. In a further configuration of the process, the temperature control medium feeds, temperature control medium returns, the channels for feeding in hydrogen and/or the filter may be produced in a circular arrangement with respect to one another within a structure.

In the process proposed, preferably in the direction in which the structures to be produced are gradually built up, the hydrogenatable material can be stabilized in different ways. In this case, the hydrogenatable material can be solidified with a different temperature or a different force. It is also possible for the hydrogenatable material to be stabilized differently within a structure to be produced. Different stabilization of the hydrogenatable material in one direction of the hydride storage means can preferably influence a pore size of the solidified hydrogenatable material, which preferably influences the absorption capacity of hydrogen of the hydrogenatable material. It is also possible, by means of different consolidation of the hydrogenatable material, to bring about varying thermal conductivity over the site within the hydride storage means. In an advantageous manner, thermal conductivity within the hydride storage element decreases with increasing distance from a temperature control medium feed and/or temperature control medium inlet.

The structures to be produced may form a matrix. The matrix may, in accordance with the invention, comprise one or more polymers and is therefore referred to as polymeric matrix. The matrix may therefore comprise one polymer or mixtures of two or more polymers. The matrix preferably comprises only one polymer. More particularly, the matrix itself may be hydrogen-storing. For example, it is possible to use ethylene (polyethylene, PE). Preference is given to utilizing a titanium-ethylene compound. In a preferred configuration, this can store up to 14% by weight of hydrogen.

The term “polymer” describes a chemical compound composed of chain or branched molecules, called macromolecules, which in turn consist of identical or equivalent units, called the constitutional repeat units. Synthetic polymers are generally plastics.

Through the use of at least one polymer, the matrix can impart good optical, mechanical, thermal and/or chemical properties to the material. For example, the hydrogen storage means, by virtue of the polymer, may have good thermal stability, resistance to the surrounding medium (oxidation resistance, corrosion resistance), good conductivity, good hydrogen absorption and storage capacity or other properties, for example mechanical strength, which would otherwise not be possible without the polymer. It is also possible to use polymers which, for example, do not enable storage of hydrogen but do enable high expansion, for example polyamide or polyvinyl acetates.

According to the invention, the polymer may be a homopolymer or a copolymer. Copolymers are polymers composed of two or more different types of monomer unit. Copolymers consisting of three different monomers are called terpolymers.

According to the invention, the polymer, for example, may also comprise a terpolymer.

Preferably, the polymer (homopolymer) has a monomer unit which, as well as carbon and hydrogen, preferably additionally includes at least one heteroatom selected from sulfur, oxygen, nitrogen and phosphorus, such that the polymer obtained, in contrast to polyethylene, for example, is not entirely nonpolar. It is also possible for at least one halogen atom selected from chlorine, bromine, fluorine, iodine and astatine to be present. Preferably, the polymer is a copolymer and/or a terpolymer in which at least one monomer unit, in addition to carbon and hydrogen, additionally includes at least one heteroatom selected from sulfur, oxygen, nitrogen and phosphorus and/or at least one halogen atom selected from chlorine, bromine, fluorine, iodine and astatine is present. It is also possible that two or more monomer units have a corresponding heteroatom and/or halogen atom.

The polymer preferably has adhesive properties with respect to the hydrogen storage material. This means that it adheres well to the hydrogen storage material itself and hence forms a matrix having stable adhesion to the hydrogen storage material even under stresses as occur during the storage of hydrogen.

The adhesive properties of the polymer enable stable introduction of the material into a hydrogen storage means and the positioning of the material at a defined point in the hydrogen storage means over a maximum period of time, i.e. over several cycles of hydrogen storage and hydrogen release. A cycle describes the operation of a single hydrogenation and subsequent dehydrogenation. The hydrogen storage material should preferably be stable over at least 500 cycles, especially over at least 1000 cycles, in order to be able to use the material economically. “Stable” in the context of the present invention means that the amount of hydrogen which can be stored and the rate at which hydrogen is stored, even after 500 or 1000 cycles, corresponds essentially to the values at the start of use of the hydrogen storage means. More particularly, “stable” means that the hydrogenatable material is kept at least roughly at the position within the hydrogen storage means where it was originally introduced into the storage means. “Stable” should especially be understood to the effect that no separation effects occur during the cycles, where finer particles separate and are removed from coarser particles.

The hydrogen storage material of the present invention is especially a low-temperature hydrogen storage material. In the course of hydrogen storage, which is an exothermic process, temperatures of up to 150° C. therefore occur. A polymer which is used for the matrix of a corresponding hydrogen storage material has to be stable at these temperatures. A preferred polymer therefore does not break down up to a temperature of 180° C., especially up to a temperature of 165° C., especially up to 145° C.

More particularly, the polymer is a polymer having a melting point of 100° C. or more, especially of 105° C. or more, but less than 150° C., especially of less than 140° C., particularly of 135° C. or less. Preferably, the density of the polymer, determined according to ISO 1183 at 20° C., is 0.7 g/cm³ or more, especially 0.8 g/cm³ or more, preferably 0.9 g/cm³ or more, but not more than 1.3 g/cm³, preferably not more than 1.25 g/cm³, especially 1.20 g/cm³ or less. The tensile strength according to ISO 527 is preferably in the range from 10 MPa to 100 MPa, especially in the range from 15 MPa to 90 MPa, more preferably in the range from 15 MPa to 80 MPa. The tensile modulus of elasticity according to ISO 527 is preferably in the range from 50 MPa to 5000 MPa, especially in the range from 55 MPa to 4500 MPa, more preferably in the range from 60 MPa to 4000 MPa. It has been found that, surprisingly, polymers having these mechanical properties are particularly stable and have good processibility. More particularly, they enable stable coherence between the matrix and the hydrogenatable material embedded therein, such that the hydrogenatable material remains at the same position within the hydrogen storage means over several cycles. This enables a long lifetime of the hydrogen storage means.

More preferably, in the context of the present invention, the polymer is selected from EVA, PMMA, EEAMA and mixtures of these polymers.

EVA (ethyl vinyl acetate) refers to a group of copolymers of ethylene and vinyl acetate having a proportion of vinyl acetate in the range from 2% by weight to 50% by weight.

Lower proportions of vinyl acetate lead to the formation of rigid films, whereas higher proportions lead to greater adhesiveness of the polymer. Typical EVAs are solid at room temperature and have tensile elongation of up to 750%. In addition, EVAs are resistant to stress cracking. EVA has the following general formula (I):

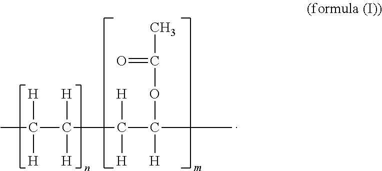

EVA in the context of the present invention preferably has a density of 0.9 g/cm³ to 1.0 g/cm³ (according to ISO 1183). Yield stress according to ISO 527 is especially 4 to 12 MPa, preferably in the range from 5 MPa to 10 MPa, particularly 5 to 8 MPa. Especially suitable are those EVAs which have tensile strength (according to ISO 527) of more than 12 MPa, especially more than 15 MPa, and less than 50 MPa, especially less than 40 MPa, particularly 25 MPa or less. Elongation at break (according to ISO 527) is especially >30% or >35%, particularly >40% or 45%, preferably >50%. The tensile modulus of elasticity is preferably in the range from 35 MPa to 120 MPa, particularly from 40 MPa to 100 MPa, preferably from 45 MPa to 90 MPa, especially from 50 MPa to 80 MPa. Suitable EVAs are sold, for example, by Axalta Coating Systems LLC under the Coathylene® CB 3547 trade name.

Polymethylmethacrylate (PMMA) is a synthetic transparent thermoplastic polymer having the following general structural formula (II):

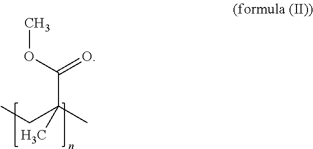

The glass transition temperature, depending on the molar mass, is about 45° C. to 130° C. The softening temperature is preferably 80° C. to 120° C., especially 90° C. to 110° C. The thermoplastic copolymer is notable for its resistance to weathering, light and UV radiation.

PMMA in the context of the present invention preferably has a density of 0.9 to 1.5 g/cm³ (according to ISO 1183), especially of 1.0 g/cm³ to 1.25 g/cm³. Especially suitable are those PMMAs which have tensile strengths (according to ISO 527) of more than 30 MPa, preferably of more than 40 MPa, especially more than 50 MPa, and less than 90 MPa, especially less than 85 MPa, particularly of 80 MPa or less. Elongation at break (according to ISO 527) is especially <10%, particularly <8%, preferably <5%. The tensile modulus of elasticity is preferably in the range from 900 MPa to 5000 MPa, preferably from 1200 to 4500 MPa, especially from 2000 MPa to 4000 MPa. Suitable PMMAs are sold, for example, by Ter Hell Plastics GmbH, Bochum, Germany, under the trade name of 7M Plexiglas® pellets.

EEAMA is a terpolymer formed from ethylene, acrylic ester and maleic acid anhydride monomer units. EEAMA has a melting point of about 102° C., depending on the molar mass. It preferably has a relative density at 20° C. (DIN 53217/ISO 2811) of 1.0 g/cm³ or less and 0.85 g/cm³ or more. Suitable EEAMAs are sold, for example, under the Coathylene® TB3580 trade name by Axalta Coating Systems LLC.

Preferably, the composite material comprises essentially the hydrogen storage material and the matrix. The proportion by weight of the matrix based on the total weight of the composite material is preferably 10% by weight or less, especially 8% by weight or less, more preferably 5% by weight or less, and is preferably at least 1% by weight and especially at least 2% by weight to 3% by weight. It is desirable to minimize the proportion by weight of the matrix. Even though the matrix is capable of storing hydrogen, the hydrogen storage capacity is not as significant as that of the hydrogen storage material itself. However, the matrix is needed in order firstly to keep any oxidation of the hydrogen storage material that occurs at a low level or prevent it entirely and to assure coherence between the particles of the material.

It is preferable that the matrix is a polymer having low crystallinity. The crystallinity of the polymer can considerably alter the properties of a material. The properties of a semicrystalline material are determined both by the crystalline and the amorphous regions of the polymer. As a result, there is a certain relationship with composite materials, which are likewise formed from two or more substances. For example, the expansion capacity of the matrix decreases with increasing density.

The matrix may also take the form of prepregs. Prepreg is the English abbreviation of “preimpregnated fibers”. Prepregs are semifinished textile products preimpregnated with a polymer, which are cured thermally and under pressure for production of components. Suitable polymers are those having a highly viscous but unpolymerized thermoset polymer matrix. The polymers preferred according to the present invention may also take the form of a prepreg.

The fibers present in the prepreg may be present as a pure unidirectional layer, as a fabric or scrim. The prepregs may, in accordance with the invention, also be comminuted and be processed as flakes or shavings together with the hydrogenatable material to give a composite material.

In one version of the present invention, the polymer may take the form of a liquid which is contacted with the hydrogenatable material. One meaning of “liquid” here is that the polymer is melted. However, the invention also encompasses dissolution of the polymer in a suitable solvent, in which case the solvent is removed again after production of the composite material, for example by evaporation. However, it is also possible that the polymer takes the form of pellets which are mixed with the hydrogenatable material. As a result of heating and/or compaction of the composite material, the polymer softens, so as to form the matrix into which the hydrogenatable material is embedded. If the polymer is used in the form of particles, i.e. of pellets, these preferably have an x₅₀ particle size (volume-based particle size) in the range from 30 μm to 60 μm, especially 40 μm to 45 μm. The x₉₀ particle size is especially 90 μm or less, preferably 80 μm or less.

The processing of the hydrogen storage material under protective gas atmosphere may be advantageous.

Hydrogenatable materials in the context of the invention are understood to mean those materials which, on addition of hydrogen, form a hydride, preferably a metal hydride. Such a hydrogenation is preferably brought about at a temperature between 20 and 500° C., preferably between 150 and 380° C., and at a pressure between 0.1 and 200 bar, preferably between 10 and 100 bar. Release of hydrogen from the hydrogenated material, preferably the metal hydride, can be achieved at a temperature between 100 and 500° C., preferably between 150 and 380° C., and at a pressure between 0.1 and 150 bar, preferably between 1 and 10 bar.

Useful hydrogenated materials include, for example, iron titanium hydrides, lanthanum nickel hydrides, vanadium hydrides, magnesium hydrides, aluminum hydrides, lithium hydrides, sodium borohydrides, lithium aluminum hydrides and ammine-borane hydrides.

The term “hydrogen storage material” describes a material having hydrogen storage capacity. This material, before and/or during the processing of the invention, may be in the hydrogenated or in the at least partly unhydrogenated state. If “hydrogenatable” is mentioned above or below, this shall not be understood in a restrictive manner, in that this term can in principle also mean the hydrogenated state of the hydrogen storage material. More particularly, it is also possible to use a mixture of hydrogenated and still unhydrogenated but hydrogenatable material in the 3D printer.

The hydrogenatable material can absorb the hydrogen and, if required, release it again. In a preferred embodiment, the material comprises particulate materials in any 3-dimensional configuration, such as particles, pellets, fibers, preferably cut fibers, flakes and/or other geometries. More particularly, the material may also take the form of sheets or powder. In this case, the material does not necessarily have a homogeneous configuration. Instead, the configuration may be regular or irregular. Particles in the context of the present invention are, for example, virtually spherical particles, and likewise particles having an irregular, angular outward shape. The surface may be smooth, but it is also possible that the surface of the material is rough and/or has unevenness and/or depressions and/or elevations. According to the invention, a hydrogen storage means may comprise the material in just one specific 3-dimensional configuration, such that all particles of the material have the same spatial extent. However, it is also possible that a hydrogen storage means comprises the material in different configurations/geometries. By virtue of a multitude of different geometries or configurations of the material, the material can be used in a multitude of different hydrogen storage means.

Preferably, the material comprises hollow bodies, for example particles having one or more cavities and/or having a hollow shape, for example a hollow fiber or an extrusion body with a hollow channel. The term “hollow fiber” describes a cylindrical fiber having one or more continuous cavities in cross section. Through the use of a hollow fiber, it is possible to combine a plurality of hollow fibers to give a hollow fiber membrane, by means of which absorption and/or release of the hydrogen from the material can be facilitated because of the high porosity.

Preferably, the hydrogenatable material has a bimodal size distribution. In this way, a higher bulk density and hence a higher density of the hydrogenatable material in the hydrogen storage means can be enabled, which increases the hydrogen storage capacity, i.e. the amount of hydrogen which can be stored in the storage means.

According to the invention, the hydrogenatable material may comprise, preferably consist of, at least one hydrogenatable metal and/or at least one hydrogenatable metal alloy.

Other hydrogenatable materials used may be:
alkaline earth metal and alkali metal alanates,
alkaline earth metal and alkali metal borohydrides,
metal-organic frameworks (MOFs) and/or
clathrates,

and, of course, respective combinations of the respective materials.

According to the invention, the material may also include non-hydrogenatable metals or metal alloys.

According to the invention, the hydrogenatable material may comprise a low-temperature hydride and/or a high-temperature hydride. The term “hydride” refers to the hydrogenatable material, irrespective of whether it is in the hydrogenated form or the non-hydrogenated form. Low-temperature hydrides store hydrogen preferably within a temperature range between −55° C. and 180° C., especially between −20° C. and 150° C., particularly between 0° C. and 140° C. High-temperature hydrides store hydrogen preferably within a temperature range of 280° C. upward, especially 300° C. upward. At the temperatures mentioned, the hydrides cannot just store hydrogen but can also release it, i.e. are able to function within these temperature ranges.

Where “hydrides” are described in this context, this is understood to mean the hydrogenatable material in its hydrogenated form and also in its non-hydrogenated form. According to the invention, in the production of hydrogen storage means, it is possible to use hydrogenatable materials in their hydrogenated or non-hydrogenated form.

For example, an adsorption of hydrogen by the hydrogenatable material and a desorption of hydrogen by the hydrogen storage material can be controlled by means of a change in pressure within a shell, the hydrogenatable material being present within the shell. The shell is advantageously designed so as to be pressure-tight and may preferably comprise a ceramic, a material, a glass, for example fiberglass, thermoset, thermoplastic, fiber-reinforced fiberglass and/or thermoplastic.

In an advantageous configuration of the process, in one process step, the material, preferably the hydrogenatable material, is applied in the pulverized state, called powder hereinafter, in a layer. This may involve using what is called additive manufacturing, for example in the form of additive layer manufacturing. In this embodiment, the 3D printer advantageously has a baseplate, a vessel for the powder and a supply for transport of the powder, for example a scraper.

It is also possible that the material uses a binder, preferably a polymer, especially one of the polymers disclosed here. Such a 3D printer thus implements what is called “binder based additive manufacturing”.

In a further configuration, the material is placed onto an already existing body geometry arranged in the 3D printer. For this purpose, it is possible to use, for example, a prefabricated body geometry, for example a punched metal sheet. The body geometry, for example the punched metal sheet, may consist, for example, of a hydrogenatable material or be a thermally conductive prefabricated body, for example made from aluminum. It is then possible to apply a structure to or into the latter by means of the 3D printer.

In addition, for example, a body produced by means of the 3D printing process may then also be sintered. For example, it is possible first to produce a precursor by means, for example, of binder based additive manufacturing. This may be followed, for example, by thermal consolidation, i.e. consolidation of the structure created, with loss of the binder. For example, a kind of “dewaxing” can be effected, in which the binder is burnt out in the sintering oven. Preferably, such a method is utilized in the production of high-temperature hydrides. At operating points with temperatures >350° C. as operating temperature, therefore, a polymer which is no longer required at a later stage is also used as binder. In one configuration, the binder is removed in the hydrogenation, namely, for example, in the case of high-temperature storage of hydrogen in the structure thus created.

In a further configuration of the process, the preferably hydrogenatable or hydrogenated material is supplied in the viscous state. In addition, the preferably hydrogenatable material can be supplied in a mixture with a polymer and/or a carbonaceous material. Such a mixture can be supplied in the form of a paste or suspension. In a particular embodiment, the preferably hydrogenatable material can be kept together with a binder in the course of supply. For example, the material can be rolled out as roll material and applied via a printhead, especially a die.

For example, it may be the case that a low-temperature hydride is used together with a high-temperature hydride. For instance, in one configuration, it may be the case that, for example, the low-temperature hydride and the high-temperature hydride are provided in a mixture in a layer of a second region. It is also possible for these each to be arranged separately in different layers or regions, especially also in different second regions. For example, it may be the case that a first region is arranged between these second regions. In a further configuration, a first region has a mixture of low- and high-temperature hydride distributed in the matrix. It is also possible that different first regions include either a low-temperature hydride or a high-temperature hydride.

Preferably, the hydrogenatable material comprises a metal selected from magnesium, titanium, iron, nickel, manganese, nickel, lanthanum, zirconium, vanadium, chromium, or a mixture of two or more of these metals. The hydrogenatable material may also include a metal alloy comprising at least one of the metals mentioned.

More preferably, the hydrogenatable material (hydrogen storage material) comprises at least one metal alloy capable of storing hydrogen and releasing it again at a temperature of 150° C. or less, especially within a temperature range from −20° C. to 140° C., especially from 0° C. to 100° C. The at least one metal alloy here is preferably selected from an alloy of the AB₅ type, the AB type and/or the AB₂ type. A and B here each denote different metals, where A and/or B are especially selected from the group comprising magnesium, titanium, iron, nickel, manganese, nickel, lanthanum, zirconium, vanadium and chromium. The indices represent the stoichiometric ratio of the metals in the particular alloy. According to the invention, the alloys here may be doped with extraneous atoms. According to the invention, the doping level may be up to 50 atom %, especially up to 40 atom % or up to 35 atom %, preferably up to 30 atom % or up to 25 atom %, particularly up to 20 atom % or up to 15 atom %, preferably up to 10 atom % or up to 5 atom %, of A and/or B. The doping can be effected, for example, with magnesium, titanium, iron, nickel, manganese, nickel, lanthanum or other lanthanides, zirconium, vanadium and/or chromium. The doping can be effected here with one or more different extraneous atoms. Alloys of the AB₅ type are readily activatable, meaning that the conditions needed for activation are similar to those in the operation of the hydrogen storage means. They additionally have a higher ductility than alloys of the AB or AB₂ type. Alloys of the AB₂ or of the AB type, by contrast, have higher mechanical stability and hardness compared to alloys of the AB₅ type. Mention may be made here by way of example of FeTi as an alloy of the AB type, TiMn₂ as an alloy of the AB₂ type and LaNi₅ as an alloy of the AB₅ type.

More preferably, the hydrogenatable material (hydrogen storage material) comprises a mixture of at least two hydrogenatable alloys, at least one alloy being of the AB₅ type and the second alloy being an alloy of the AB type and/or the AB₂ type. The proportion of the alloy of the AB₅ type is especially 1% by weight to 50% by weight, especially 2% by weight to 40% by weight, more preferably 5% by weight to 30% by weight and particularly 5% by weight to 20% by weight, based on the total weight of the hydrogenatable material.

The hydrogenatable material (hydrogen storage material) is preferably in particulate form (particles).

The particles especially have a particle size x₅₀ of 20 μm to 700 μm, preferably of 25 μm to 500 μm, particularly of 30 μm to 400 μm, especially 50 μm to 300 μm. x₅₀ means that 50% of the particles have a median particle size equal to or less than the value mentioned. The particle size was determined by means of laser diffraction, but can also be effected, for example, by sieve analysis. The median particle size in the present case is the particle size based on weight, the particle size based on volume being the same in the present case. What is reported here is the particle size of the hydrogenatable material before it is subjected to hydrogenation for the first time. During the storage of hydrogen, stresses occur within the material, which can lead to a reduction in the x₅₀ particle size over several cycles.

Preferably, the hydrogenatable material is incorporated in the structure produced in the form of a matrix to such a firm degree that it decreases in size on storage of hydrogen. Preference is therefore given to using, as hydrogenatable material, particulate material which breaks up while the matrix remains at least predominantly undestroyed. This result is surprising, since it was expected that the matrix would if anything tend to break up on expansion as a result of the increase in volume of the hydrogenatable material during the storage of hydrogen when there is high expansion because of the increase in volume. It is assumed at present that the outside forces acting on the particles, as a result of the binding within the matrix, when the volume increases, lead to particle breakup together with the stresses within the particles resulting from the increase in volume. Breakup of the particles was discovered particularly clearly on incorporation into polymer material in the matrix. The matrix composed of polymer material was capable of keeping the particles broken up in this way in a stable fixed position as well.

Tests have incidentally shown that, in the case of utilization of a binder, especially of an adhesive binder in the matrix for fixing of these particles, particularly good fixed positioning within the matrix is enabled. A binder content may preferably be between 2% by volume and 3% by volume of the matrix volume.

Preferably, there is a change in the particle size because of breakup of the particles resulting from the storage of hydrogen by a factor of 0.6, more preferably by a factor of 0.4, based on the x₅₀ particle size at the start and after 100 storage operations.

A hydride storage element to be manufactured which comprises hydrogenatable material is preferably produced on the baseplate, which can advantageously be lowered and, in the lowered state, is bounded by walls, the walls forming the vessel. Preferably, within the vessel, a powder bed of hydrogen storage material powder is produced. The powder bed surrounds at least a substructure of the hydride storage element, if it has already been produced. Particularly advantageously, the substructure of the hydride storage element already produced is covered in a process step with a layer of hydrogen storage material powder in particular. The material powder is distributed with the scraper, which is preferably movable horizontally. In this configuration of the process, the material powder is preferably transported not just to the sites which, in their totality, form the structure to be produced, but also to sites beside the structure to be produced.

In an advantageous development of the process, in a further process step, the hydrogenatable material powder is remelted locally by means of laser melting at the sites which, in their totality, form the structure to be produced. This involves directing a laser of the 3D printer onto the sites in the material powder to be remelted. After the melting, the hydrogenatable material solidifies and is in stabilized form. The local remelting is preferably effected at specific spots, the coordinates of the points where the remelting is effected being obtained by means of the first step described above.

There is at least conversion of a geometric description of a structure to be produced for the hydride storage means to individual coordinates which specify the respective sites to which the laser is directed in the remelting of the hydrogenatable material powder. There is preferably overlap of the respective sites where the remelting is effected. In this embodiment of the process claimed, it is first possible to transport the hydrogenatable material to a site corresponding to a point in the structure to be produced and then a geometric description of this structure of the hydride storage means to be produced can be read out.

In the remelting of a complete structure to be produced for the hydrogenatable material, the laser beam or another treatment unit for local stabilization of the material powder preferably scans all points which, in their totality, form the structure to be produced. Cutouts for the temperature control medium feed and/or the temperature control medium return may be provided in a structure, in which case the laser beam does not scan and preferably does not heat such points in the structure of the hydrogenatable material where cutouts, leadthroughs, apertures, or the like are provided.

As an alternative to remelting, the preferably hydrogenatable material can also be heated to a temperature lower than the melting temperature of the hydrogenatable material. A lower supply of heat to the preferably hydrogenatable material compared to laser melting can be achieved, for example, by means of supply of light, for example by means of UV radiation. In this case, the preferably hydrogenatable material can be baked. More particularly, the hydrogenatable material may be surrounded by a polymer which is cured by means of a directed light beam. Rather than the hydrogenatable material, it is also possible for a non-hydrogenatable material in powder form to be present in a vessel, to be applied layer by layer, and to be stabilized in accordance with the steps described above.

After the stabilization of the preferably hydrogenatable material, a stabilized structure is present. In a further process step, the stabilized structure is lowered, preferably by a height corresponding to a structure of the preferably hydrogenatable material which is subsequently to be built on. In a downstream process step, the preferably hydrogenatable material powder is again applied to the stabilized structure in a further step. These process steps are repeated until each structure of the hydride storage means to be produced has been produced.

In a development, the laser beam or the light beam can also, at at least one point corresponding to a point in the structure to be produced, not heat the preferably hydrogenatable material or heat it at a lower temperature than an average temperature in the remelting or baking at the other points within the structure to be produced. Such different stabilization can preferably affect the pore size of the hydrogenatable material, preferably increase it, with an effect on, preferably an increase in, the absorption capacity of the preferably hydrogenatable material of hydrogen. In a specific embodiment, hydrogenatable material having a pore size of 1 nm to 0.2 mm can be used.

In a further embodiment of the process, in a process step, the hydrogenatable material is solidified by means of electron beam melting. In this case, by contrast with laser beam melting, the energy for remelting can be generated by means of a locally directed electron beam.

In a further advantageous configuration, the preferably hydrogenatable material is solidified by means of pressing. In this case, it is possible with preference to move a pressing device of the 3D printer locally past the point where the hydrogenatable material is to be compressed, and compress it locally. In a further configuration of the process, an entire structure of the hydrogenatable material to be produced is pressed in one step by means of the 3D printer, or the pressing device.

In an advantageous manner, prior to the pressing, it is possible to transport a substance which, on pressing with the hydrogen storage material, enters into a chemical, preferably organic, bond and brings about solidification of the hydrogenatable material at the points which, in their totality, form the structure to be produced. In this configuration of the process, the pressing device may be designed as a flat plate which does not contain the information as to the structure to be produced. The substance may, for example, be a carbonaceous material or an adhesive.

In an advantageous configuration of the process, at least one structure of the hydride storage element which includes the hydrogen storage material and a carbonaceous or generally heat-conducting material is generated. Particularly advantageously, a process in which at least one structure comprising expanded natural graphite as carbonaceous material is generated is proposed. Preferably, the process claimed produces a hydride storage element having a proportion of 1 to 3 percent expanded natural graphite.

The carbonaceous material can be transported by means of a supply device of the 3D printer to at least one site corresponding to at least one point in the structure to be produced. The transport of the carbonaceous material can advantageously also be effected together with the hydrogen storage material. More preferably, the carbonaceous material and the hydrogen storage material are in a mixed state on transport, preferably in a bonded state.

In a development, the hydrogen storage material can be transported separately by means of the supply of the 3D printer to the respective points which, in their totality, form the structure to be produced. The supply, and in an advantageous execution also a plurality of supply devices, is moved toward these points by means of a drive unit of the 3D printer. Thereafter, the hydrogen storage material is stabilized at these points, for example by means of electron beam melting, laser beam melting, light irradiation and/or pressing.

A further configuration of the process envisages stabilization of the hydrogenatable material alternately by means of electron beam melting, laser beam melting, light irradiation and/or pressing. This can be effected independently of the preceding transport of the hydrogenatable material to the points which, in their totality, form the structure to be produced. It is also possible to achieve stabilization of the hydrogen storage material by means of a combination of the methods of electron beam melting, laser beam melting, light irradiation, adhesive bonding and/or pressing.

In an advantageous development of the process, the hydrogenatable material is held together with an adhesive in the course of transport.

In an advantageous development of the process, the preferably hydrogenatable material is hydrogenated prior to the stabilization. In the hydrogenation, the volume of the hydrogenatable material preferably increases. Stabilization of the preferably hydrogenatable material in the hydrogenated state can advantageously reduce any change in volume of the hydride storage means in the course of later adsorption and desorption of hydrogen. It is also possible for energy in the hydrogen bound within the hydride to be used as an energy for remelting of the hydride.

Additionally proposed is use of a 3D printer for production of at least a portion of a hydride storage means, comprising at least one hydrogenatable material. In an advantageous manner, the 3D printer is used for production of a prototype of at least a portion of a hydride storage element, comprising at least one hydrogen storage material.

In the context of the invention, the term “3D printer” is understood quite generally to mean a device for stepwise, especially a layer-by-layer, formation of a three-dimensional structure. The stepwise supply of material can be effected, for example, in powder form, in the form of a molten strand from a reservoir vessel or from a roll or in some other way. It is also possible to implement one of the methods described above or else below by means of a 3D printer. Alternatively or additionally, it is also possible to supply material films or preformed, mainly flat material bodies. In the device, the respective material supplied is bonded to an already produced substructure, specifically in a cohesive manner by welding and/or bonding (the latter with addition of adhesive or activation of binder present in the material supplied, unless the material itself functions as binder). Preferably, the 3D printer has one or more nozzles, by means of which exact positioning of material to be processed is enabled. If a real application is required, it is also possible to use a slot die or another application geometry of a material supply means.

Further features, advantages and details of the invention are apparent from the description of a preferred working example which follows, and from the figures. The figures show:

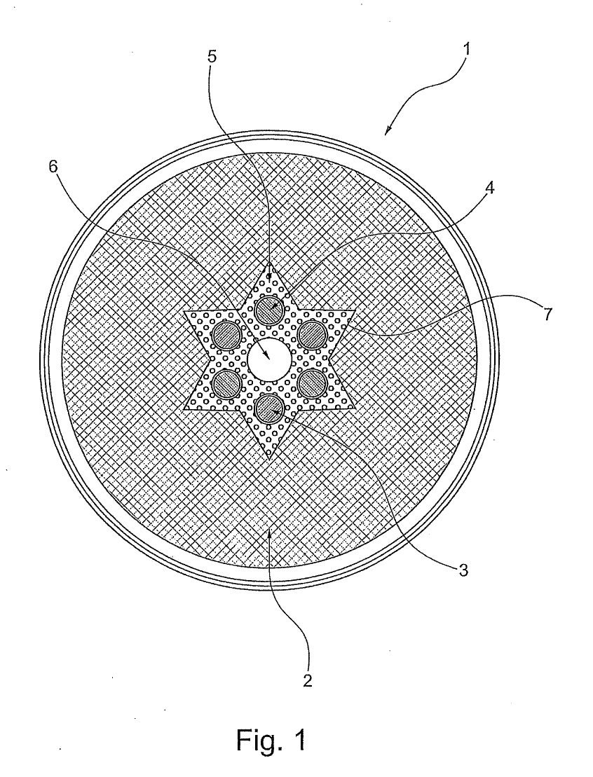

FIG. 1 a structure of a hydride storage means;

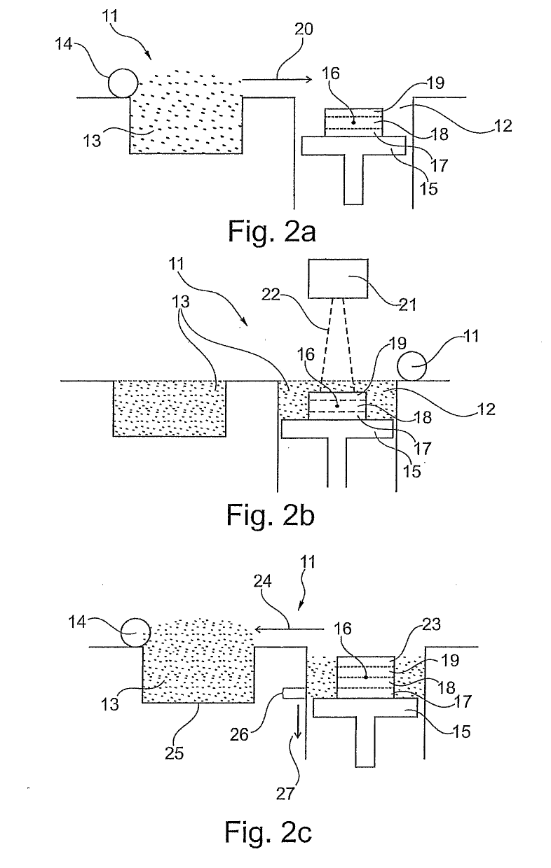

FIG. 2 the above-described steps 2 and 4 of the claimed process for producing a structure of a hydride storage means;

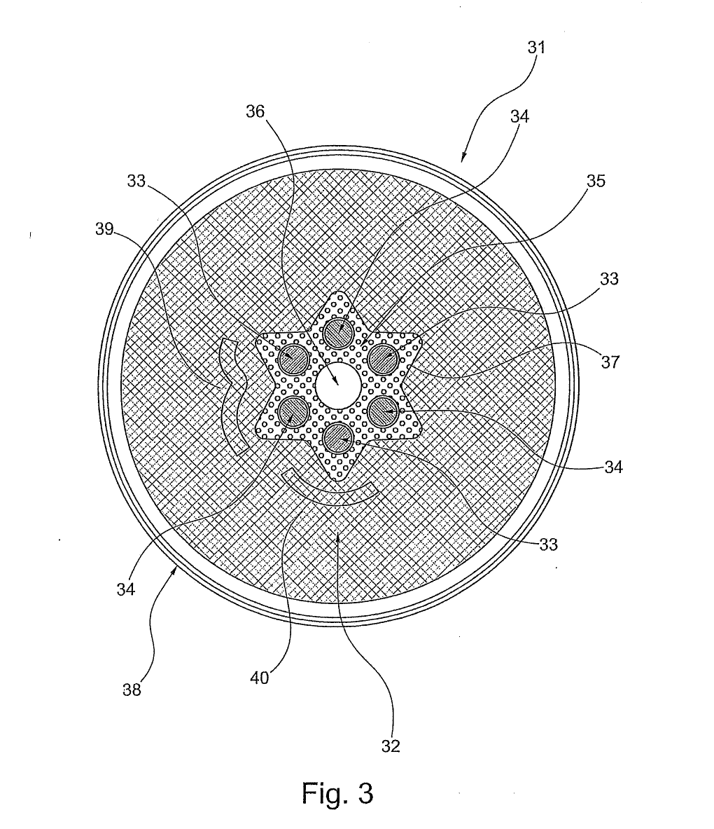

FIG. 3 a further structure of a hydride storage means;

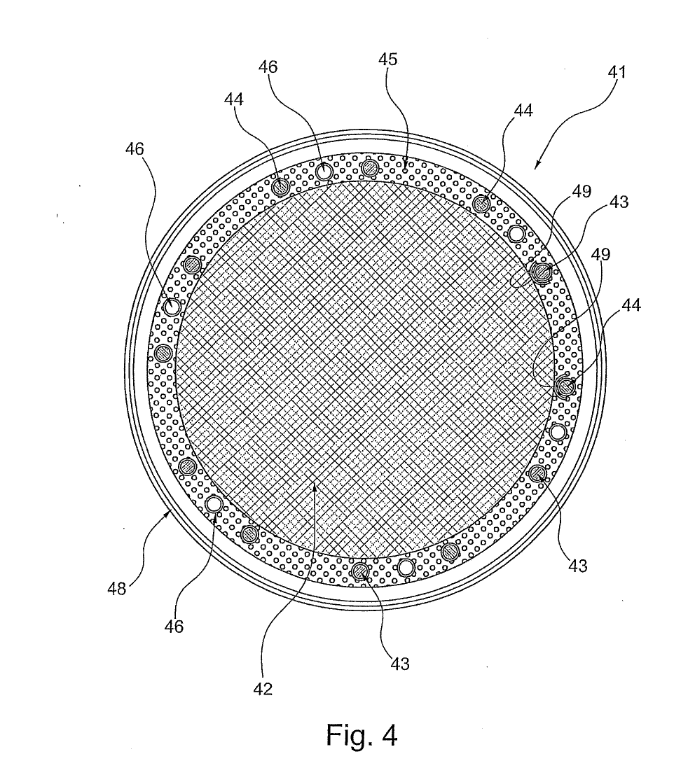

FIG. 4 a further structure of a hydride storage means;

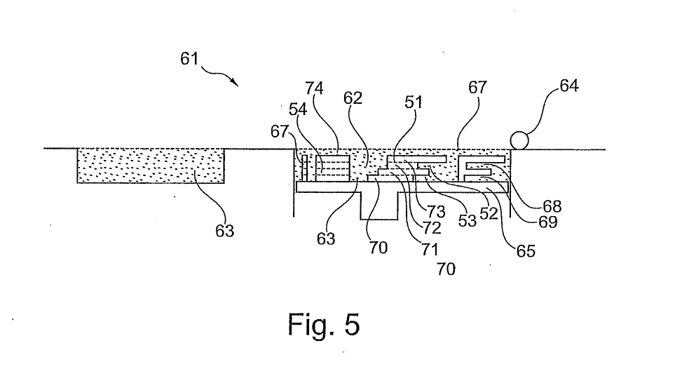

FIG. 5 a production of a hydride storage means with undercuts by means of the process claimed.

FIG. 1 shows a structure of a hydride storage element 1 (also referred to hereinafter as hydride storage means), comprising hydrogen storage material 2, a temperature control medium return channel 3, a temperature control medium feed channel 4, a filter element 5 and a hydrogen supply channel 6. In addition, the hydride storage element 1 has a boundary region 7 between the filter element 5 and the hydrogenatable material 2, configured in a star shape.

FIG. 2 shows steps 2 and 4 of the claimed process for structured production of a hydride storage means. FIG. 2a shows a 3D printer 11 with a working space 12 for preferably hydrogenatable material 13 in the preferably pulverulent state and a supply unit 14 in the form of a gate valve for discharge of the material 13 to the working space 12 of the 3D printer. On a baseplate 15 in the working space 12 of the 3D printer 11 is an already produced portion of a hydride storage means 16. In the context of the invention, an already produced portion of a hydride storage means also constitutes a hydride storage means. The hydride storage means 16 shown in FIG. 2a has a first structure 17, a second structure 18 and a third structure 19 composed of preferably hydrogenatable material, the structures 17, 18 and 19 being arranged one on top of another.

For production of a new structure, in step 2 of the process claimed, the supply unit 14 is moved in a direction 20, the supply unit 14 being in contact with the material 13 and the material 13 being transported in the direction 20 toward the working space 12. In this step 2, the already produced structures 17, 18 and 19 of the hydride storage means are covered by the material 13 and, after this step, are surrounded by the material 13, as shown in FIG. 2b.

After step 2, the material 13, in a subsequent step 4, is stabilized at the sites which, in their totality, correspond to a shape of the structure to be produced, by means, for example, of a laser 21 of the 3D printer 11. This can be effected with a laser beam 22 which is run to the particular sites in the structure to be produced and activated. In a particular configuration of the process, the material 13 and/or the laser beam 22 is/are supplied manually to the particular sites. Preferably, a second laser beam 23 is produced by means of the laser 21 simultaneously with the first laser beam 22 and directed to the respective sites of the structure to be produced. The coordinates of all points that define the respective structure to be produced, the space or in a plane, are read out prior to step 4 from a file having the geometric description of the hydride storage means 16 to be produced.

After the laser treatment of the material 13, it solidifies and forms a stabilized portion of the structure 23 to be produced for the hydride storage means 16, as shown in FIG. 2c. Once this portion of the structure 23 has stabilized, the supply unit 14 is moved back in a direction 24 and then new material 13 is dispensed from a reservoir vessel 25. In addition, the baseplate 15 is moved downward by an offset 26 in a direction 27. The offset 26 corresponds to the thickness of the substructure to be produced in the next step. The steps shown in FIGS. 2a to 2c are repeated as frequently as required to complete the hydride storage means.

FIG. 3 shows a further configuration of a structure 31 of a hydride storage means, for example the hydride storage means 16. The structure 31 comprises hydrogenatable material 32, portions of each of a temperature control medium return with, for example, three channels 33, a temperature control medium feed with, for example, three channels 34, a filter element 35 and a hydrogen supply channel 36. In addition, the structure 31 has a boundary region 37 between the portion of the filter element 35 and the hydrogenatable material 32, having a rounded star shape. In addition, the structure 31 has a portion of a shell 38 surrounding the hydrogenatable material 32. Partial regions comprising heat-conducting material 39 and 40, for example graphite, may be arranged within the structure 31 for better conduction of heat, preferably close to the channels 33, 34 of the temperature control medium return and the temperature control medium feed 34.

FIG. 4 shows a further configuration of a structure 41 of a hydride storage means, for example the hydride storage means 16. The structure 41 comprises hydrogenatable material 42, a portion of a temperature control medium return, having several channels 43, a temperature control medium feed, having several channels 44, a filter element 45 and a hydrogen supply, having several channels 46. In addition, the structure 41 has a boundary region 47 between the portion of the filter element 45 and the hydrogenatable material 42, configured in circular form. In addition, the structure 41 has a portion of a shell 48 surrounding the hydrogenatable material 42. It is additionally possible for a coating 49 for protection of the temperature control medium return and the temperature control medium feed from oxidation to be arranged within the structure 41 shown in FIG. 5.

The process claimed can preferably be used to produce a hydride storage means having structures which vary in terms of their geometric form. For example, the structure 17 of the hydride storage means 16 of FIGS. 2a-c may have the shape of the structure 31 of FIG. 3 and the structure 19 of the hydride storage means 16 of FIGS. 2a-c may have the shape of the structure of the hydride storage means 1 shown in FIG. 1. The structure 18 according to FIGS. 2a-c arranged between the structure 17 and the structure 19 may have a shape possessed by a boundary region between the hydrogenatable material and the filter material which has a transitional shape between the star-shaped boundary region 7 of FIG. 1 and the rounded star-shaped boundary region 37 of FIG. 3.

It is also possible to produce a hydride storage means with a transition between the structure 31 shown in FIG. 3 and the structure 41 shown in FIG. 4 by the process claimed. In this case, in a structure arranged between the structure 31 and the structure 41, it is possible in each case to produce branching of one or all of the temperature control medium feed channels 34, the temperature control medium return channels 33 and/or the hydrogen supply channel 36, such that the temperature control medium feed channels 34, the temperature control medium return channels 33 and/or the hydrogen supply channel 36 merge correspondingly into the channels 44, 43 and 46 of the temperature control medium feed, the temperature control medium return and/or the hydrogen supply shown in FIG. 4.

FIG. 5 shows how, by the process claimed, firstly a first hydride storage means 51 with a first undercut 52 and a second undercut 53 is produced, and secondly how a second hydride storage means 54 arranged alongside the first hydride storage means 51 is produced. Additionally shown is a 3D printer 61 with a vessel 62 (working space) for hydrogenatable material powder 63 and a supply unit 64 for supply of the hydrogenatable material powder 63 to the vessel 62. On a baseplate 65 of the 3D printer 61 is arranged an already produced portion of a hydride storage means 66 and of a shell 67 surrounding the hydride storage means 66, the shell having a first undercut 68 and a second undercut 69. The individual process steps for production of the already produced structures 70, 71, 72 and 73 and the subsequent new structure 74 correspond to the process steps described in the figure description for FIG. 2.

The figures show hydride storage means having an outer shell. This outer shell can likewise be produced by means of the 3D printer. However, it is also possible to produce the hydride storage element by means of a 3D printer, in order then to install it in an outer shell. If the outer shell has internal undercuts/projections, it is appropriately produced together with the hydride storage element and the formation of the various channels (as described above) in the 3D printer at the same time.

For processing of a plurality of different materials in the 3D printer, they are preferably transported from different reservoir vessels selectively to the working space, where they are processed to produce the structure.

1. A process for producing a hydride storage element comprising a hydrogen storage material, wherein at least a portion of the hydride storage material is produced by means of a 3D printer, wherein a structure of the hydride storage element is produced by the following steps:
a) readout of a geometric description of the structure of the hydride storage element to be produced and
b) supply of a preferably pourable material, preferably a hydrogen storage material, to a site within the 3D printer corresponding to at least one point in the structure to be produced.

2. The process as claimed in claim 1, wherein the step of supplying a heat-conducting material to a site within the 3D printer corresponding to at least one point in the structure to be produced.

3. The process as claimed in claim 1, wherein the step of stabilizing the material, preferably the hydrogen storage material, by means of the 3D printer, preferably by applying an adhesive or binder, by welding or by producing another cohesive bond of particles of a pourable material with one another and/or with any material already present in the 3D printer.

4. The process as claimed in claim 1, wherein steps a), b) are repeated as often as required for a structure corresponding to the geometric description to have been produced, preferably with creation of a primarily hydrogen-storing layer, a primarily hydrogen-storing region or a primarily hydrogen-storing structure, a primarily heat-conducting layer, a primarily heat-conducting region or a primarily heat-conducting structure, or a primarily gas-conducting layer, a primarily gas-conducting region or a primarily gas-conducting structure.

5. The process as claimed in claim 1, wherein at least steps a), b) are repeated, with arrangement of the structures that have arisen therein alongside one another and formation of at least a portion of the hydride storage element.

6. The process as claimed in claim 1, wherein the structure is produced layer by layer.

7. The process as claimed in claim 1, wherein the material is stabilized by the 3D printer by means of a support structure that surrounds the material.

8. The process as claimed in claim 7, wherein the support structure is produced by means of a polymer.

9. The process as claimed in claim 7, wherein the support structure is produced by means of a heat-conducting, preferably carbonaceous material.

10. The process as claimed in claim 7, wherein the support structure is produced using a wire, especially a metal wire of high thermal conductivity preferably comprising copper, aluminum, silver and/or gold.

11. The process as claimed in claim 1, wherein the material, especially the hydrogen storage material, is supplied in pulverulent form.

12. The process as claimed in claim 1, wherein the material, especially the hydrogen storage material, is supplied in the viscous state.

13. The process as claimed in claim 1, wherein the material, preferably the hydrogen storage material, is supplied in a mixture with a polymer and/or a heat-conducting, especially carbonaceous material.

14. The process as claimed in claim 1, wherein the material, especially the hydrogen storage material, is solidified by means of pressing.

15. The process as claimed in claim 1, wherein the material, especially the hydrogen storage material, is kept together with a binder in the course of supply.

16. The process as claimed in claim 1, wherein the material is hydrogenatable and is hydrogenated prior to the stabilization, preferably prior to the supply.

17. A hydride storage element comprising a hydrogen storage material, structured by a method as claimed in claim 1.

18. The hydride storage element as claimed in claim 17, wherein a temperature control medium return channel and/or a temperature control medium feed channel and/or a filter element and/or a hydrogen supply channel.

19. The hydride storage element as claimed in claim 18, wherein the temperature control medium return channel, the temperature control medium feed channel and/or the hydrogen supply channel are in a circular arrangement with respect to one another.

20. The hydride storage element as claimed in claim 19, wherein the insides of the temperature control medium return channel and/or the temperature control medium feed channel are formed by and/or adjoin a heat-conducting material, preferably a carbonaceous and/or metallic material.

21. A 3D printer having a supply apparatus for material, preferably a hydrogen-storing and/or primarily heat-conducting material, and a baseplate for layer-by-layer formation of a structure of a hydride storage element.

22. The use of a 3D printer for producing at least a portion of a hydride storage element comprising at least one hydrogenatable material.
